(19) United States
(12) Patent Application Publication
(10) Pub. No.: US 2006/0154226 A1
(43) Pub. Date: Jul. 13, 2006

(54) Learning support systems

(76) Inventor: M. Richard Maxfield, Salt Lake City, UT (US)

Correspondence Address: Michael F. Krieger;KIRTON & McCONKIE, 1800 Eagle Gate Tower, 60 East South Temple, Salt Lake City, UT, 84111, US

(21) Appl. No.: 11/300,634

(22) Filed: Dec. 14, 2005

Related U.S. Application Data
(60) Provisional application No. 60/638,755, filed on Dec. 27, 2004.

(51) Int. Cl. G09B 7/00

(52) U.S. Cl. 434/323

(57) ABSTRACT

The invention relates to a learning process that is personalized to the learner. Student performance and learning behavior is tracked and analyzed, feedback and reinforcement is given, and educational or training stakeholders are engaged. Continuous improvement of the student, instructor, curriculum, and learning process is envisioned to accelerate learning.

### RELATED APPLICATIONS

This application claims priority to U.S. provisional patent application Ser. No. 60/638,755 filed Dec. 27, 2004.

### FIELD OF THE INVENTION

This invention relates to education and skill training support systems. In particular, this invention relates to training and educational systems which utilize student learning behaviors to provide student feedback and reinforcement to individually modify future curriculum and methods for learning the curriculum.

### BACKGROUND AND RELATED ART

The process of educating a learner (e.g., student or employee), particularly through public education systems that utilized disparate standards for tracking education depending on the geographic location of the educational and training institution yields unsatisfactory results. Standardized tests like the SAT's demonstrate disparate outcomes depending on the different instructional standards utilized by education and training institutions at different locations. Many states have adopted specific minimum standards to assess student competency. The standards tend to ensure the students are performing at grade level and have a basic understanding of a core group of subject matters. These types of systems have been established in an effort to ensure that students in disparate geographical locations will receive the benefit of some basic knowledge or skills prior to graduation from the educational process. Additionally, having universal specified minimum standards incorporated across multiple geographical locations provides a safety net for students, allowing a typical student to move from one geographic location to another comfortably and with the confidence that their local educational system has been similar to, and provided them with, the core skills and education necessary to succeed in other geographic locations. Unfortunately, the present systems for teaching and training fail to incorporate principles of flexibility, which would allow a student to maximize his or her learning potential.

In general, current technology based products designed to support training and educational environments are designed to support traditional classroom and core structures. Accordingly, the current technology fails to provide learning specialization and flexibility to students or trainees to optimize their learning potential.

There are a number of inventions providing systems and methods for interactive, adaptive and individualized computer assisted instruction. Cook et al., U.S. Pat. No. 6,201,948 provides for a remote agent for each student, which adapts and provides individualized guidance to the students, and controls to the algorithmic computer assisted instructional materials. Cook et al., U.S. Pat. No. 5,727,950 relates to a system a method for interactive, adaptive, and individualized computer-assisted instruction, also included is an agent for each student. Computer-assisted instruction often does not provide adequate instruction to those students who benefit from human skill instruction. Computer-assisted instruction may also result in student's proficiency in a topic, but does nothing to develop students who cannot interact with others.

Hakim, U.S. Pat. No. 6,760,748 provides an interactive electronic instructional system as a teaching interface between a teacher and a student as data is transmitted from the teacher's terminal to the student's terminal to provide teacher guided instructional data base on student progression.

Abrhamson et al., U.S. Pat. No. 5,002,491 provides an interactive electronic classroom system for enabling teachers to teach students concepts via computer network and to receive immediate feedback regarding how well students had learned the concepts.

Lockwood, U.S. Pat. No. 6,554,618 provides for a system and method of integrating individualized, objectively managed computer assisted learning and directive instruction. Lockwood's invention designs a system to replace textbooks.

Siefert, U.S. Pat. No. 6,386,883 relates to a computer assisted education system in which the school curriculum is the word in a computer repository. Siefert provides for a learning profile which is maintained for every student and indicates the student's capabilities, preferred learning style and progress.

These teacher driven systems and multi-media instruction based methods do not provide character based feedback nor do they modify instructional methods based upon test results and monitored behavioral tendencies of a particular student. Accordingly, they fail to incorporate a variety of important learning related indicia necessary to facilitate maximum learning.

### SUMMARY OF THE INVENTION

The invention relates to methods and devices which provide individualized learning method and apparatus, employing multiple modes of instruction including classroom, student groups, teachers, textbooks, library sources, lectures and computer database networks. Accordingly, some embodiments of the invention provide continuous learning feedback and reinforcement from multiple media sources and triggers. Some embodiments provide follow-up action based upon data conditions, as well as provides objectively measured learning rates.

In some embodiments, the learning rate of a student is increased with a modified and flexible curriculum, guiding the teacher and learner in the ways most effective for that learner. In some embodiments, the flexible curriculum created for the student is a product of measuring student progression as a result of utilizing various education mediums.

In some embodiments, a student is given an option to learn from a peer, or is provided with a list of peers, from which they may learn a specified concept or skill set. Accordingly, in some embodiments, a peer who has acquired a skill set or has mastered an educational process or concept may be utilized to teach other students. Consequently, in some embodiments the peer group acts as a teacher.

In some embodiments, periodic random testing is utilized to assess a learner's progress and development.

In some embodiments, the activity and learning-related behavior of an individual is monitored and tracked so as to identify behaviors that optimize learning. In some embodiments, the behavioral tracking may include taking a pre-assessment test to identify the learner's baseline educational/training level. In some embodiments, the behavioral tracking may include tracking when a learner (e.g. student or employee) first selects a learning module. Other embodiments track the period of time over which the module is open for learning. In some embodiments, the behavioral tracking system may include tracking a time that a learner spends on a concept or skill. In some embodiments, the system may track who the learner goes to for help or to what sources the learner goes to supplement the learning associated with a particular training module. In some embodiments, the system may track whether the learner wants to practice the skill set involved in the module. In some embodiments, the behavioral tracking may include tracking when the learner takes tests and whether or not the learner passes the tests. In some embodiments, the behavioral tracking may track the number of attempts to pass a test prior to passing. In some embodiments, the behavioral tracking systems of the invention may provide randomized spot testing to assess the learner's progress.

In some embodiments, the learner is given options for different sources to learn from, including student groups, teachers, textbook library sources, lectures and computer based systems and networks. In some embodiments of the invention, the data acquired during behavioral tracking is analyzed in an analysis engine to assess the progress of the student, and may be utilized to determine how a flexible education curriculum should be modified for a particular student. In some embodiments, the flexibility of the system may include an identification of the educational sources particularly effective for a student. In other embodiments, the analysis provides the learner with character feedback, allowing the learner to receive feedback regarding whether or not their behaviors may be modified to improve their educational progress.

Some embodiments of the invention provide for curriculum mapping. In some embodiments, the curriculum mapping utilizes a qualified expert to provide a map for what must be known to become competent in a particular area. Those skills and educational attributes may be segregated into modules which may be subsequently learned or acquired as skills by a learner. Accordingly, in some embodiments a learner is only required to train for what is essential to a given task or job.

These and other features and advantages of the invention will be set forth or will become more fully apparent in the description that follows and in the appended claims. The features and advantage may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF DRAWINGS

FIG. 1 is an example of a flowchart of an embodiment of the system analysis and improvement process associated with the invention;

FIG. 2 is an example of a learning process of an embodiment associated with the invention;

FIG. 3 is an example of a schematic equipment layout of an embodiment associated with the invention; and

FIG. 4 is an example of a learning map associated with the invention. This example is a subset of a 5^{th} Grade math curriculum.

### DETAILED DESCRIPTION OF THE INVENTION

The invention related to education and skill training support systems. In particular, the invention provides personalized concept and skill training and flexible individualized curriculum pathways to meet the needs of individuals. Some embodiments provide a list of skill resources available to a learner who is interested in a desired subject. These skill resources may be written text, human instructors, experts, lecturers, performances, electronic teaching databases, computer systems, and/or student peers who may be utilized to teach a learner. In some embodiments the invention exposes a learner to a desired skill resource in incremental learning units. These incremental learning units are broken down such that the rate of learning can be tracked. These learning units may be independent of, or dependent on, previous learning concepts and are small enough to identify when early intervention is required.

In some embodiments, the invention comprises accumulating a computer data base of the type of skill or concept resource selected and utilized by each learner. The invention may further comprise in some embodiments the periodic examination of the learner's proficiency of the incremental learning unit in response to his request. This examination may be written, electronic or by manual performance, such as when one is required to weld metal or perform a manual/physical task. Some embodiments comprise utilizing a computer database to track, store and analyze the results of the examination along with the time of exposure to a learning resource and the types of skill resource utilized. Some embodiments may further comprise utilizing a computer data processing program to track the learner's progress in mastering incremental learning units and the type of skill resources required to master the same.

Some embodiments may comprise generating periodic reports for review by a learner and others to provide an objective measure of the learner's mode of learning as well as the learning rate. The computer may thus flag learning disabilities as well as provide the student, employer, teacher, or parent, review or feedback as to the learner's progress, proficiency, and mastery of a subject. Some embodiments provide feedback comprising additional information related to behaviors which the student may modify in order to maximize the learning process.

In some embodiments, competency is defined as a demonstrable acquisition of specific, knowledge or ability. In some embodiments, the learning approach utilized allows all students to be supported and encouraged to progress continuously and seamlessly through a hierarchy of subject-related competencies as fast as they are able to demonstrate mastery of each component competency. In some embodiments, this means that a student stays with their age group, but is allowed to move on in their learning as soon as they have mastered the material upon which the new learning rests. In some embodiments, self-help learning materials are provided so students are less dependent on their teacher. This frees the teacher to help individual students as needed. In some embodiments, support tools lighten the work of teachers and help the teacher facilitate the learning of students. In some embodiments, mastery and speed of learning become the measurement of progress.

In some embodiments, a student is required to achieve a mastery of a particular concept or skill that they have or are learning before moving onto the next competency. In some embodiments, observation is accomplished by continually measuring the progress of each students learning. In some embodiments, the measurement consists of at least two kinds of data collection. One comes from tracking activities associated from learning and the other from the learning itself (e.g. the behaviors of a learner during a learning process including which resources are utilized, and the time spent at each stage of the learning process). In some embodiments, the latter kind of data comes from breaking down subject matter into small components and measuring the related success. In some embodiments, the system may act as “observational eyes” to help teachers, and other stakeholders such as parents, supervisors, etc. to guide and support daily progress of learners as well as their personal development.

In some embodiments the proposed learning support system goes beyond what is available in current classroom management or learning management system in several respects. First, in some embodiments, the system supports competency-based operation and self-paced process. Second, in some embodiments, it allows curriculum to be broken down into smaller modules and the learning tracked through those modules. Third, in some embodiments, it tracks student's activities and behaviors associated with learning. This may be done with capturing the clock time as students activate modules, request alternative materials, request help, request a practice test, signal readiness for testing and the time at which they successfully master a competency. Fourth, in some embodiments, it incorporates the learning research in the analysis and feedback software. Fifth, in some embodiments, the invention provides the ability to support continuous improvement by tracking the benefit of every change in the system and any new tool of intervention. For example in preferred embodiments, the pre and post effects on the same student or group of students can be automatically determined. Accordingly, some embodiments provide continuous direction, evaluation and flexibility of improvement efforts. Sixth, some embodiments provide integration and alignment of the learning support system with competency based classroom operation. This provides the capability to extend classroom functions beyond the physical walls of the schools. It allows a learner to take full advantage of the Internet and other distance learning opportunities. This system provides a structure that allows any concept or skill to be learned at any time through any medium. It also allows for learning history needed for transfers or later upgrade training.

In some embodiments, the curriculum is mapped by a qualified expert who provides a map of what needs to be known to be competent in an area. This allows a learner to learn or to train for only what is essential to a task or job. In some embodiments of the invention, a student/learner is given a pre-assessment test. The pre-assessment test may be utilized to modify the curriculum map for that particular student to allow a student to begin his or her educational program based upon the student's pre-existing level or competency in a subject area.

In some embodiments, once a student embarks on the educational process laid out in the curriculum map, a student has one or more modules open or available for learning. The student may identify particular modules which are of interest or which the student would prefer to master first. In some embodiments, the student is given the option to learn from various sources including peers, student groups, text books, classroom materials and/or online educational resources.

In some embodiments when some students have begun the educational process, the behavior and the learning of the student may be tracked. In some embodiments various behavioral indicia or benchmarks may be utilized to identify behaviors of a given student which lead to successful or accelerated learning. This may be accomplished by correlating rapid improvement in competencies with certain tracked behaviors of a particular learner. In some embodiments the system may track when a particular module is open for learning. When a student begins to learn about any given subject, a module will be accessible to the student based upon the pre-assessment of the student's capabilities. The period between the time a module is open for learning and the time the student begins learning in that module is in some embodiments a behavior that is utilized in a behavioral analysis to determine optimal learning behaviors for a given student.

In some embodiments a second behavioral element which may be tracked, recorded and/or analyzed to enhance learning, is the period of time a module is active for a student. For example, in some embodiments once a module is open for a student to learn, the student may subsequently activate it to learn the concepts or skills of the particular module. Once a module is activated, in some embodiments, the system tracks the period of time prior to the student becoming competent at the skill set or knowledge based required by the module. In some embodiments, the time that a student spends working on a project may also be tracked.

In some embodiments of the invention, the system tracks the various branches for learning opportunities which are accessible to a student and may also track which of the branches of learning material the student utilizes to assist in learning. For example, the system may track whether the student utilized text books, peer groups or a teacher to assist the student in the learning process. In some embodiments of the invention, the system may track whether and how much the student practiced the skill set associated with a particular module. Thus, in some embodiments of the invention, the system may develop an analysis of whether a student should practice more or is spending too much time practicing a particular skill set prior to attempting to validate or pass off the skill set associated to a particular module or competency.

In some embodiments of the invention the system may track when a student takes a test. This time may be tracked in some embodiments from when the module or competency was open from when the student activated it, or from any other time point in the learning process including the time period of the completion of the practice exams or from a time point correlated with the utilization of particular curricular materials including accessing resources such as teachers, peers, mentors, or other experts.

In some embodiments of the invention, the system is designed to track whether or not a student has passed a module or has established a competency level necessary to apply the skill emphasized in the particular module. In some embodiments of the invention the student or learner may be randomly tested to assess progress. Other forms of randomized spot checking may be utilized to assess user progress and the relationship between the utilization of various resources and the learning progress of a learner. The randomized assessment may also be utilized to assess what a student's behaviors are associated with accelerated learning.

In some embodiments of the invention, a student may receive instant messages with results that may be verified and validated by the student's teacher. This feedback may provide not only an assessment of the level of competency achieved by a student but feedback on character development or behavioral skills which may be modified by the student in order to accelerate the learning process. The feedback in some embodiments of the invention may include who the student has gone to for help, how often the student says they are ready to take a test, and patterns on how the student has approached the learning process. This feedback provided for the students would allow the system of some embodiments of the invention to provide the student with feedback on not only their position relative to the curriculum activity but feedback on their learning development allowing a student to incorporate character and behavioral skills which will accelerate the movement of a student through the learning process. For example, the system of the invention may provide feedback to a student informing them that they are behaving in a risk adverse manner—such as, practicing a test too many times, procrastinating, validating or passing off a particular competency—and that the student's learning progress is being impeded or slowed by such risk adverse behavior. Accordingly, in some embodiments of the invention a student is trained to incorporate certain character based or behavioral skills which will accelerate the learning process.

In some embodiments, the invention contemplates the use of an analysis engine. This engine may be utilized to evaluate the data tracked by the systems of the invention. Accordingly, in some embodiments of the invention a computer system may be utilized to collect objective data about the information learned by a student and data related to the character or behavioral traits of each student. The analysis engine contemplated by the invention would utilize data to provide feedback to the students, employer, supervisor, teachers or parents of a learner to assist them in evaluating the learning progress of a student. In some embodiments, the engine may further comprise the capacity to modify the subject matter map for a given student based upon particular behavioral traits or educational biases. The engine in some embodiments may analyze the behavioral details of learning and tracking the individual steps a student goes through in a learning process to provide feedback to the learner. This feedback may include suggestions for modifying the learner's behavior to maximize the learning capacity of an individual. For example, in preferred embodiments the analysis tool would recognize certain behaviors that produced accelerated learning for a particular student. In some embodiments a learner may experience accelerated learning when utilizing a small peer support group as a primary source for learning. In such case, the data tracking and analyzing systems in some embodiments of the invention would provide a student feedback prompting the student to increase the amount of time spent learning in small groups of peers. Alternatively, a student may experience accelerated learning when utilizing text as a primary source of learning material. The data collection and analysis engines associated with some embodiments could be utilized to provide feedback to such a student notifying or suggesting that the student spend more time using text as a primary source for the learning process. Accordingly, because in some embodiments of the invention, the computer system utilizes complex and sophisticated data tracking systems which include behavioral data and is capable of analyzing such data, the analytic engine of the invention provides for substantial flexibility allowing the specific map for a particular student to be modified based not only upon the competency of the student but also upon the student's particular behavioral traits and strengths.

In some embodiments, as the learner selects the skill resources of interest, the system is dynamically controlled by the continual computer feedback generated. It also takes advantage of all skill resources available employing those most useful to a particular learner. Students who solely focus on a particular learning resource are identified and directed to other types of skill resources. For example, those students solely relying on computer learning are directed to join discussion groups to be able to develop socialization skills in the area. A student is thus exposed to a wide variety of learning scenarios including peer discussion and problem groups to provide a well-rounded multi-dimensional educational experience.

In some embodiments, learner progress variables may be weighted, such that an accurate rate of progress can be determined regardless of cultural bias. For example, second language students may be tested on concepts taught in English as well as the learner's native language. Testing may also be in this native language to provide an objective evaluation of the skill acquisition without regard to language barriers.

In some embodiments, where a particular curriculum is required to be completed, a subject matter map, or a learning map, custom designed to meet the educational needs of a particular individual, is produced, listing the incremental concepts to be completed. These personalized maps are created by comparing the required curriculum with learner competencies, evidenced by test scores. These maps generated from learner data before going through the above method and apparatus sequence to complete and master those incremental learning units outlined in the map by a learner to meet its proficiency requirements. Progress toward completing the learning map is tracked by the computer as outlined above as the learner completes each incremental learning unit. In some embodiments, immediate feedback is provided as the learner progresses through a program. This instantaneous feedback provides positive reinforcement and quick identification of learning problems. This may also allow for efficient allocation of teaching resources and applying the same only where required.

One preferred embodiment of the method and apparatus employs software. The software may consist of a variety of modules for accomplishing a variety of tasks. In some embodiments, it may track individual progress on learning tasks or any list of activities, provides feedback and reinforcement, coordinates efforts among people and automatically triggers corrective and follow-up action based upon data conditions. When the follow-up action is formed properly the system can optimize the work of any individual or the operation of any organization. The software may be utilized in a variety of learning environments (e.g. in close client tracking by doctors, caseworkers and parole officers).

In some embodiments, the software may provide continuous improvement measurement. The software may be utilized for business as well as education.

The following examples set forth and present various embodiments of the Learning support systems of the invention. These examples are not intended to be limiting in any way, but are merely illustrative of the benefits and advantages of utilizing embodiments of the invention.

### EXAMPLE 1

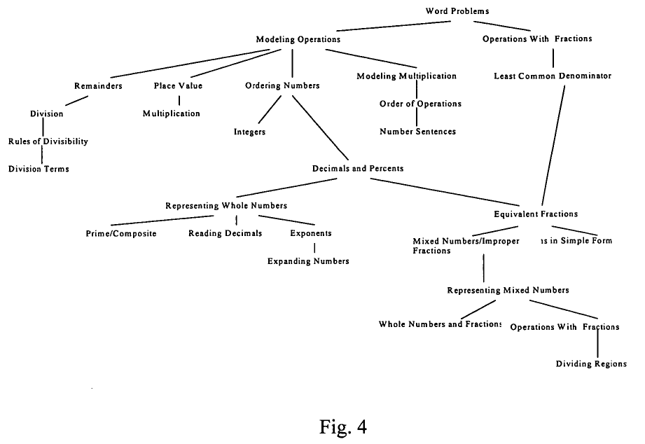

In some embodiments, a classroom and learning support system is operated as follows:
1. A student logs in for the day or the class if not automatically done based upon the schedules. If there is no activity for the day by a student on the managing computer it becomes obvious to the system that the student is absent.
2. A student indicates the module(s) from their learning map that they will utilize (see FIG. 4 for an example of a learning map). For example, a student may elect to work on any of the curriculum modules open to the student for learning.
3. A student is directed to learning materials which will assist the learner in learning.

In preferred embodiments, this direction is based upon the students learning style. For example, electronic formatted materials are utilized where available and/or a student may be directed to paper-based materials or peer feedback groups. In this example the paper based materials may be selected from a wide variety of materials including, basic acquisition materials, practice materials, enrichment materials and/or alternative learning style materials
4. A student requests help as needed from teacher or from another student who has mastered the concept or skill of that module. In preferred embodiments the computer system will produce a list of available resources accounting for the type of resource best suited to aiding the particular learning style of the learner. For example, a student attempting to master a particular mathematical skill may be directed to the students who have mastered that mathematical skill in the same classroom.
5. A student may request practice assessment if available.
6. A student indicates readiness to demonstrate competency. For example, a student may automatically take electronic testing if an electronic form of testing is available; or a teacher may test or observe the student during the learning process.
7. Assessment results are captured into the database and feedback is given to the student. For example, a student may receive feedback that more study is needed prior to passing the competency or the particular skill set. Upon receiving the feedback that more study is needed, a student may be prompted to utilize particular resources to acquire additional information, and/or to seek help from student or teachers for additional guidance regarding the unmastered materials. A student may receive feedback from the teacher that the particular concept or skill has been passed by the student and additional modules of learning may be opened to the student for studying.
8. The computer captures all computer entries and enters times for later aggregation and analysis and computes the learner's progress. For example, the rate of learning and changes in rate of learning for each student are tracked during each step of the process as described in the invention. The gain in scores per unit of time may be tracked for each student. Accordingly, the computer system of the invention will have the capacity to track the periods of time a student makes the most rapid gains and in association with particular behaviors (e.g., does the student make the most rapid gains by utilizing a text book or small peer group discussion). Additionally, in some embodiments, the computer may track the consistency of behavioral traits as evidenced by computer interface patterns allowing the computer system to assess which behavioral traits are highly correlated with accelerated learning for each particular student. In some embodiments, the computer system will additionally be capable of tracking curriculum concepts and learning materials that are slowing the student down and adjust the curriculum and provide suggestions regarding behavioral traits which will accelerate the student's learning through the slower materials. Further, the computer will identify patterns of difficulty as indicated by assessment data.
9. A student selects a new module of learning to work on. For example, students with short attention spans can work on several things at the same time if they feel the need to do so, while students who tend to be more focused on a particular subject may spend longer blocks of time learning about one subject.
10. The computer analyzes the data for individual students and provides continual feedback on progress and attainments. In preferred embodiments, feedback is tailored to individual needs and frequently includes special reinforcement techniques such as appropriate complements. Teachers also receive feedback from the system. Parents are continually informed about the progress of their child and provided suggestions for enhancement. If the home does not have email, telephone voice mail can be used. Parents can go online at any time to see the progress of their individual student via a unique identification number.
11. Aggregate data on teachers, classrooms and schools are used to identify where systemic improvement can take place. In some embodiment, limitations in curriculum, learning materials, instruction, or operation are quickly identified and direction given for improvement. A continuous improvement function is included in the learning support system.

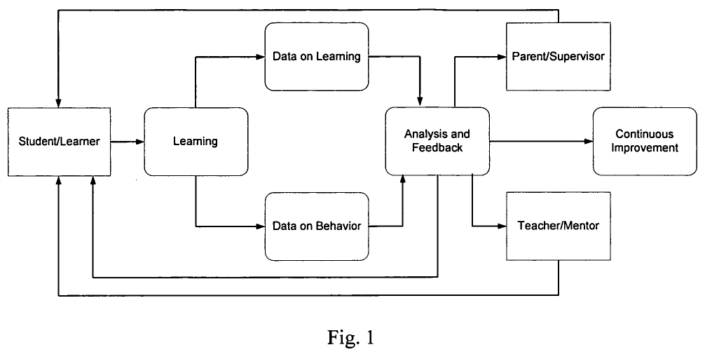

The operational flow of the example above is depicted in FIG. 1.

### EXAMPLE 2

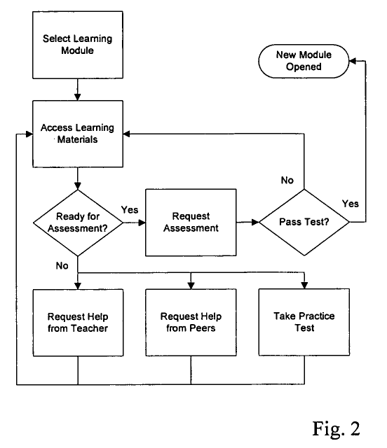

As illustrated in FIG. 2, the student engages in a dynamic curriculum to meet their needs by selecting from a list of multi-media educational resources available to the student to learn a concept or skill. After exposure to the study materials, the student may request help from the teacher as needed, but primarily relies on ether textual materials or resources. Periodically, the student requests testing and is then evaluated by the computer as to its competency. If the student passes, the learner moves on to another concept or skill. If not, interaction occurs with the teacher regarding the additional skills required. A record is computer generated and continually updated regarding the student's testing and skills assessment for monitoring.

### EXAMPLE 3

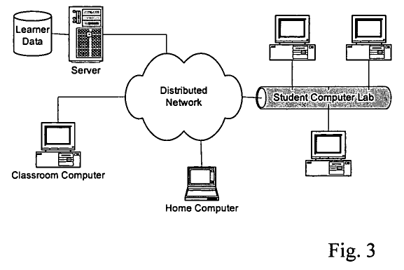

FIG. 3 illustrates an embodiment of an example of the equipment layout utilized in preferred embodiments of the invention. Databases of the skill resources available and the skill resources selected for review and testing are operably associated with the computer central processor controlled by a software program. An output device then periodically provides a report of a student's progress and proficiency in response to instructions generated by the computer.

In classrooms using paper-based learning materials, one computer per classroom is sufficient to utilize the method and apparatus. As more learning materials become electronically based or used for intervention purposes, additional computers in the classroom may be utilized. Classroom operation, in some embodiments, is such that computer labs are generally not needed except to teach computer-related skills. Specialized subject matter learning labs are no longer needed and their related computer equipments can be redistributed. The use of computers for subject-matter learning can be accommodated in all classrooms utilizing the system of the present. This saves the operational and management costs associated with those labs.

The invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A learning system comprising:
a computer system which stores information related to subject matter modules, which presents one or more learning modules to a learner and assesses the learner's competency of the topic;
a computer system which allows for the selection of educational components relevant to the learner's interest and skill level; and
a student profile which contains information about the learner's behavior and competency level.

2. The system of claim 1, wherein the student profile contains information about the time interval over which an educational module is opened for learning.

3. The system of claim 1, wherein the profile contains information about how many educational modules are open at a given time by a learner.

4. The system of claim 1, wherein the profile contains information about the activation time for a particular educational module by learner.

5. The system of claim 1, wherein the profile contains information about the time which has elapsed from when the learning module is opened to when the learning module is passed off.

6. The system of claim 1, wherein the profile contains information about the branches of the materials in a curriculum hierarchy the learner utilizes to develop proficiency with the material contained within a particular module.

7. The system of claim 1, wherein the profile contains information related to the number of times a learner attempts to demonstrate competency of a particular module.

8. The system of claim 1, wherein the profile contains information related to the curriculum materials utilized during the educational process.

9. The system of claim 1, wherein a computer system analyzes the data in the student profile and provides feedback to the learner in order to maximize the rate of learning.

10. The system of claim 1, wherein a computer system utilizes behavioral information from the profile to provide feedback to a student regarding student behaviors that may be modified to increase the rate of learning.

11. The system of claim 1, utilized to educate adults in a commercial setting.

12. The system of claim 1, wherein the system is utilized to educate students in a school setting.

13. The system of claim 1, wherein the education materials utilized to teach a student may be selected from a list consisting of classroom instruction, student groups, teachers, text books, library sources, lectures, computer database networks, written text, human instructors or lecturers, performances, electronic teaching databases, computer systems, Internet resources, and peers.

14. The system of claim 1, further comprising periodic and random assessment of the learner to verify subject retention.

15. The system of claim 1, wherein the profile for each student contains information related to behavioral skills wherein the behavioral skills are comprised of information related to how often a student indicates they are ready to take an exam.

16. The system of claim 1, wherein the profile for each student contains behavioral information related to how often the student asks a teacher, expert, or peer a question related to a particular learning module.

17. The system of claim 1, wherein the system further comprises the step of utilizing the profile created for each student to modify the curriculum utilized by the student and to modify the suggestions for modifying the student's behavioral practices.

18. A method for accelerating the educational process comprising:
storing information related to curriculum modules on a computer database presenting one or more educational modules to a student;
assessing the student's mastery of the information or skill covered by the module;
allowing the learner to select an educational program relevant to the learner's interest and skill level;
tracking information about the learner's behavior and educational level in a student profile; and
utilizing the student profile, populated with behavioral data, to modify the curriculum and method of learning the curriculum for each individual learner.

19. The method of claim 18, wherein the student profile contains information selected from a list comprising: the time interval over which an educational module is opened for learning; information about how many educational modules are open at a given time by a learner; information about the activation time for a particular educational module by learner; information about the time which has elapsed from when the learning module is opened to when the learning module is passed off; information about the branches of the materials in the curriculum the learner utilizes to develop proficiency with the material contained within a particular module; information related to the number of times a learner attempts to test out of a particular module;
information related to the curriculum materials utilized during the educational process.

20. The method of claim 18, wherein a computer system analyzes the data in the student profile and provides feedback to the learner in order to maximize the rate of learning.

21. The method of claim 18, wherein a computer system utilizes behavioral information from the profile to provide feedback to a student regarding student behaviors that may be modified to increase the rate of learning.

22. The method of claim 18, utilized to educate learners in an environment selected from a list comprising: adults in a work setting; and students in a school setting.

23. The method of claim 18, wherein the education materials utilized to teach a student may be selected from a list comprising classroom instruction, student groups, teachers, text books, library sources, lectures, computer database networks, written text, human instructors or lecturers, performances, electronic teaching databases, computer systems, Internet resources, and peers.

24. The method of claim 18, further comprising spot checking to verify learner progress.

25. The method of claim 18, wherein the profile for each student contains information related to behavioral skills wherein the behavioral skills are comprised of information related to how often a student indicates they are ready to take an exam.

26. The method of claim 18, wherein the profile for each student contains behavioral information related to how often the student asks a teacher, expert, or peer a question related to a particular learning module.

27. The method of claim 18, wherein the method further comprises the step of utilizing the profile created for each student to modify the curriculum utilized by the student and to modify the suggestions for modifying the student's behavioral practices.
